(19) United States
(12) Patent Application Publication
(10) Pub. No.: US 2005/0232583 A1
(43) Pub. Date: Oct. 20, 2005

(54) Control apparatus, control method, and control program product

(76) Inventor: Tsukasa Kubota, Kagoshima-ken (JP)

Correspondence Address: MARTINE PENILLA & GENCARELLA, LLP, 710 LAKEWAY DRIVE, SUITE 200, SUNNYVALE, CA, 94085, US

(21) Appl. No.: 11/097,872

(22) Filed: Mar. 31, 2005

(30) Foreign Application Priority Data
Apr. 1, 2004 (JP) 2004-109052

(51) Int. Cl. H04N 5/76

(52) U.S. Cl. 386/46; 386/125

(57) ABSTRACT

A control apparatus comprising: a storage medium that is stored with control screen components; a detection unit that detects services provided by apparatuses connected to a network; a control screen display unit that displays, on a screen, the control screen components associated with the detected services so that the control screen components can be selected; a control selection unit that accepts the selection of the control screen component displayed on the screen; and a control unit that allows the service associated with the selected control screen component to be provided to the corresponding apparatus.

### CROSS-REFERENCE TO RELATED APPLICATIONS

The disclosure of Japanese Patent Application No.JP2004-109052 filed on Apr. 1, 2004 including the specification, drawings and abstract is incorporated herein by reference in its entirety.

### BACKGROUND OF THE INVENTION

1. Field of the Invention

The present invention relates to a control apparatus, a control method, and a control program product, and more particularly, to an HMI (Human Machine Interface) for integrally controlling various of apparatuses connected to a network.

2. Description of the Related Art

In general, in order to set up peripheral devices of a computer such that the devices can be used, an end user has to carry out complicated setting. Therefore, the user needs to have a basic knowledge of the computer. As one of solutions for solving this problem, Universal Plug and Play (hereinafter, referred to as ‘UPnP’) has attracted public attention in recent years. If one network is configured by a plurality of UPnP apparatuses, for example, a television connected to the network can be used for various purposes, such as the display of image data stored in a file server as well as the display of television broadcasting. Further, within the network, various of apparatuses are adapted to be controlled by a control point composed of a desktop personal computer (PC), a remote controller of a television, etc. Furthermore, a function that cannot be performed by a single apparatus can be realized by executing a program that associates a plurality of apparatuses with the control point.

### SUMMARY OF THE INVENTION

An advantage of the invention is to provide a control apparatus, a control method, and a control program product, capable of easily manipulating various apparatuses connected to a network.

(1) In order to accomplish the advantage, a control apparatus according to an aspect of the invention includes a storage medium that is stored with control screen components; a detection unit that detects services provided by apparatuses connected to a network; a control screen display unit that displays, on a screen, the control screen components associated with the detected services so that the control screen components can be selected; a control selection unit that accepts the selection of the control screen component displayed on the screen; and a control unit that allows the service associated with the selected control screen component to be provided to the corresponding apparatus.

When a user selects the control screen component displayed on the screen by the control apparatus, the service associated with the selected control screen component is provided to the apparatus connected to the network for offering the service under the control of the control apparatus. Thus, the user can be supplied with the services provided from various of apparatuses through the control apparatus. The control apparatus detects the services provided by the apparatuses connected to the network to display, on the screen, one of the control screen components previously stored in the control apparatus that is associated with the detected service so that the control screen component can be selected. Thus, it is unnecessary to input, into the control apparatus, a control screen component for controlling an additional apparatus when the apparatus is additionally connected to the network. If it is not required to input, into the control apparatus, the control screen component for controlling an additional apparatus when the apparatus is additionally connected to the network, it is possible to easily manipulate various apparatuses connected to the network.

(2) The plurality of control screen components and the plurality of services defined by a device control protocol may be stored in the storage medium such that the plurality of control screen components and the plurality of services are associated with each other. In addition, the detection unit may acquire, from the apparatuses connected to the network, control information for controlling the apparatuses. Further, the control unit may control the apparatuses and allow the services to be provided to the apparatuses, based on the acquired control information.

By previously preparing the control screen components for every service defined by the device control protocol, the universality of the control apparatus can be improved. Further, since the control apparatus acquires, from the apparatuses, information (control information) for providing the services to the apparatuses, it is not necessary for a user to input such information into the control apparatus.

(3) The control screen display unit may display, on the screen, the control screen components associated with functions, which are realized by a combination of different services provided by the plurality of apparatuses, so that the control screen component can be selected. In addition, the control unit may allow the plurality of services for realizing the function associated with the selected control screen component to be provided to the apparatuses.

The control screen components are previously stored in the control apparatus in accordance with the function that is realized by a combination of different services provided by the plurality of apparatuses, and the control apparatus provides the services to the plurality of apparatuses, based on the selected control screen component. Accordingly, a user can easily employ a function, which is hardly realized by a single device, through the control apparatus.

(4) The functions and the plurality of the services defined by a device control protocol may be stored in the storage medium such that the plurality of services and the functions are associated with each other.

According to this structure, by previously preparing the functions corresponding to the services defined by a device control protocol, it is possible to improve the universality of the control apparatus.

(5) The control apparatus may further include an object selection screen display unit that displays an object on the screen so that the object can be selected, and an object selection unit that accepts the selection of the object displayed on the screen. In addition, the control screen display unit may display, on the screen, one of the plurality of control screen components associated with the selected object such that the control screen component can be selected.

When a user selects an object, the control apparatus selectively displays, on the screen, the control screen display component corresponding to the selected object. Thus, although the number of apparatuses connected to the network increases, it is possible to prevent the manipulation of the control apparatus from deteriorating since the control screen components unsuitable for the object intended by the user are displayed on the screen.

(6) The object and the plurality of services defined by a device control protocol may be stored in the storage medium such that the object and the plurality of services are associated with each other.

According to this structure, since objects attainable corresponding to the services defined by the device control protocol are prepared in advance, the universality of the control apparatus can be improved.

(7) In order to accomplish the advantage, a control method according to another aspect of the invention includes: detecting services provided by apparatuses connected to a network; displaying, on a screen, one of previously stored control screen components associated with the detected service so that the control screen component can be selected; accepting the selection of the control screen component displayed on the screen; and providing the service associated with the selected control screen component to the corresponding apparatus.

(8) In order to accomplish the object, a control program product according to still another aspect of the invention that allows a computer to function as: a detection unit that detects services provided by apparatuses connected to a network; a control screen display unit that displays, on a screen, one of previously stored control screen components associated with the detected service so that the control screen component can be selected; a control selection unit that accepts the selection of the control screen component displayed on the screen; and a control unit that allows the service associated with the selected control screen component to be provided to the corresponding apparatus.

Furthermore, the respective functions of the plurality of units according to the aspect of the invention are realized by hardware resources whose functions are specified by their own constructions, hardware resources whose functions are specified by a program, or a combination thereof. Moreover, the respective functions of the plurality of units are realized by hardware resources that are physically independent, but the invention is not limited thereto.

### BRIEF DESCRIPTION OF THE DRAWINGS

FIG. 1 is a schematic diagram illustrating a screen according to an embodiment of the invention;

FIG. 2 is a schematic diagram illustrating a network according to an embodiment of the invention;

FIG. 3 is a block diagram illustrating the hardware of a control apparatus according to an embodiment of the invention;

FIG. 4 is a flow chart illustrating a process flow of the control apparatus according to an embodiment of the invention;

FIG. 5 is a schematic diagram illustrating a service management table of the control apparatus according to an embodiment of the invention;

FIG. 6 is a schematic diagram illustrating a screen management table of the control apparatus according to an embodiment of the invention;

FIG. 7 is a schematic diagram illustrating the change of the screen of the control apparatus according to an embodiment of the invention;

FIG. 8 is a schematic diagram illustrating the change of the screen of the control apparatus according to an embodiment of the invention;

FIG. 9 is a schematic diagram illustrating a process flow of the control apparatus according to an embodiment of the invention;

FIG. 10 is a schematic diagram illustrating the process flow of the control apparatus according to an embodiment of the invention;

FIG. 11 is a schematic diagram illustrating the screen of the control apparatus according to an embodiment of the invention;

FIG. 12 is a flow chart illustrating a process flow of the control apparatus according to an embodiment of the invention; and

FIG. 13 is a schematic diagram illustrating an object management table according to an embodiment of the invention.

### DESCRIPTION OF THE PREFERRED EMBODIMENTS

Hereinafter, a control apparatus, a control method, and a control program according to the preferred embodiments of the invention will be described in detail with reference to the accompanying drawings.

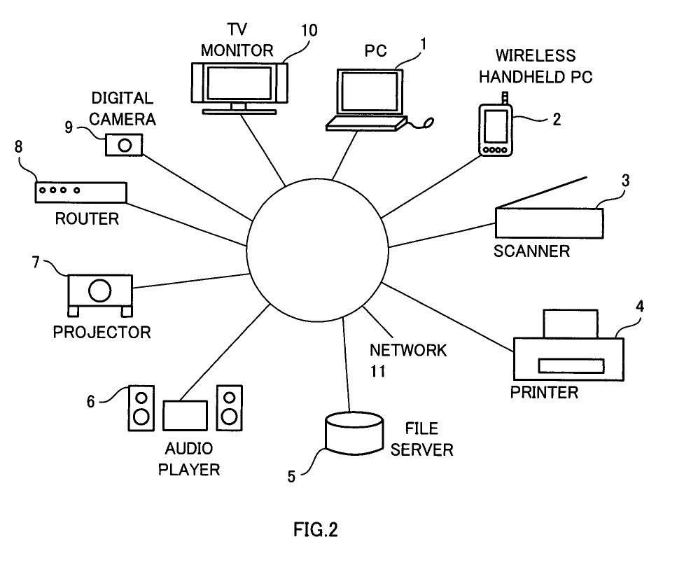

A control apparatus according to an embodiment of the invention is a UPnP control point composed of, for example, a personal computer (PC) 1 shown in FIG. 2. In the present embodiment, the PC 1 is given as an example. However, it is understood that the control apparatus according to the invention may be composed of a wireless handheld PC 2, a mobile phone (not shown), and the like. A control program according to the present embodiment can be executed by a UPnP control point, such as the PC 1. UPnP apparatuses connected to a UPnP network 11 can include a scanner 3, a printer 4, a file server 5, an audio player 6, a projector 7, a router 8, a digital camera 9, a TV monitor 10, and so on.

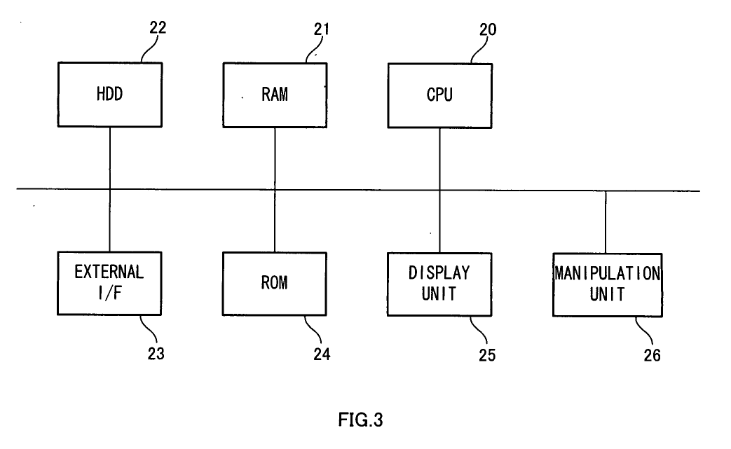

FIG. 3 is a block diagram illustrating hardware constituting the PC 1, serving as a control apparatus. The PC 1 includes a CPU 20, a RAM 21, a hard disk drive (HDD) 22, an external interface 23, a ROM 24, a display unit 25, and a manipulation unit 26. The CPU 20 executes a control program to perform a detection process of detecting the UPnP apparatuses and control information for providing services to the UPnP apparatuses, a control screen display process of displaying, on the screen, control screen components associated with the detected services such that they can be selected, a control selection process of accepting the selection of the control screen components displayed on the screen, a control process of providing the service corresponding to the selected control screen component to the UPnP apparatus, an object selection screen display process of displaying, on the screen, objects realized by a plurality of apparatuses so that they can be selected, and the like, thereby controlling the UPnP apparatuses. The term ‘control screen components’ means screen constitutional components which are manipulated by a pointing device, such as a mouse, to receive manipulations, such as the call of a predetermined program and the change of parameters, in an interactive way. The control screen components can include, for example, a button, a drop-down list box, and so on.

The ROM 24 is a memory stored with programs required for an initial operation of the CPU 20. The RAM 21 is a memory for temporarily storing control programs and data accessed by the control programs. The HDD 22, serving as a storage medium, is an external storage unit for storing the control programs, various of data accessed by the control programs, etc. However, the control programs may be stored in a semiconductor memory, such as a flash memory.

The external interface 23 is an interface for connecting the PC 1 and external devices, and is composed of, for example, a LAN card. The display unit 25 is composed of a cathode ray tube (CRT), a liquid crystal display (LCD), a display controller, or the like. The display unit 25 serves to display a graphical user interface (GUI) screen composed of the screen constitutional components, such as control screen components. The manipulation unit 26, serving as control selection means and object selection means, is composed of a keyboard and a pointing device (a mouse, tablet, etc.).

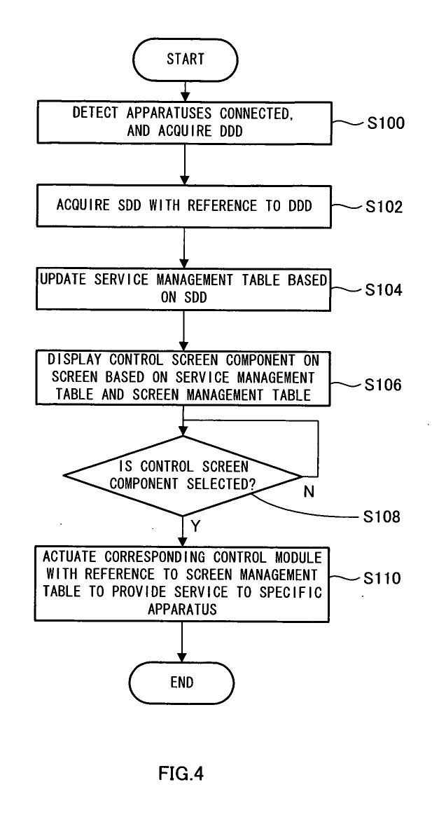

FIG. 4 is a flow chart illustrating a process flow for controlling the UPnP apparatuses using the PC 1 that operates as a control point. The PC 1 executes the control program to allow the process shown in FIG. 4 to be performed.

If being connected to a network, the UPnP apparatus informs other UPnP apparatuses of its existence in a regular manner by using the Simple Service Discovery Protocol (SSDP) over the network. The SSDP is a multicast discovery protocol obtained by extending a Hypertext Transfer Protocol (HTTP) header. A link to the Device Description Document (DDD) described in the extensible Markup Language (XML) format is included in the discovery packet. A URL for referring to the Service Description Document (SDD) defined by UPnP as well as a device type, a maker name, a model name, etc., is described in the DDD. The PC 1 detects a UPnP apparatus using the SSDP and acquires the DDD of the detected apparatus (S100). At this time, the PC 1 can independently detect the UPnP apparatus by inquiring the access status of other UPnP apparatuses according to the SSDP.

The PC 1 then acquires the SDD in which the service provided by the apparatus is described in detail in the XML format, with reference to the URL described in the DDD (S102). When acquiring the SDD, the PC 1 can determine the service provided by the apparatus connected to the UPnP network 11, and can acquire information on action and state parameters as control information for providing a service to the apparatus.

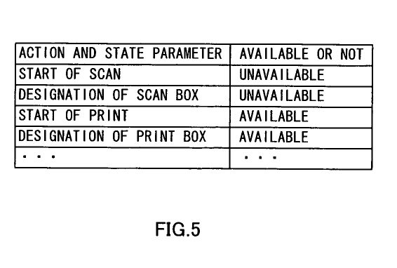

Next, the PC 1 updates a service management table shown in FIG. 5, based on the SDD (S104). The service management table has data for managing whether all services defined by the Device Control Protocol (DCP) are regularly provided to the UPnP apparatuses actually connected to the UPnP network 11. Information on whether the action and state parameters of the services defined by the DCP are available, respectively, and minimal information (the destination of a message, etc.) required for employing each service are described in the service management table.

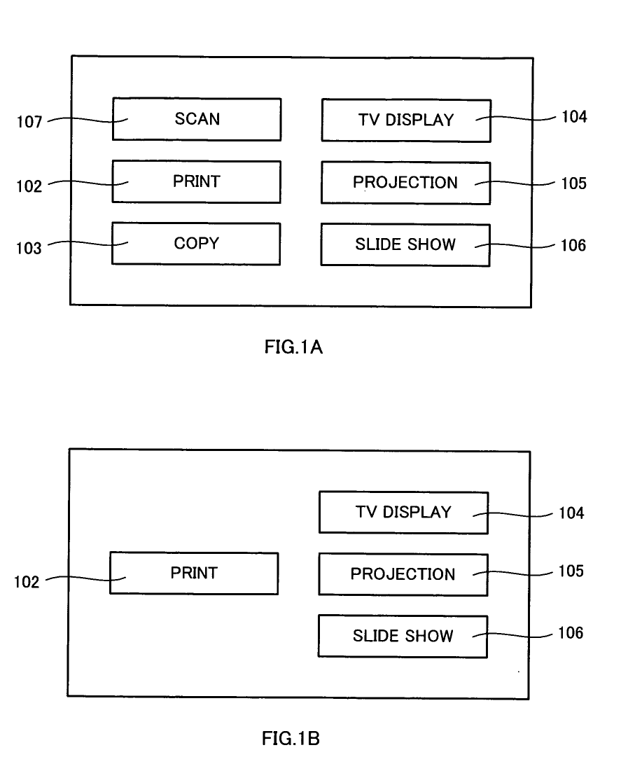

The PC 1 displays the control screen component corresponding to the service provided by the apparatus connected to the UPnP network 11 on the screen of the display unit 25, e.g., as shown in FIG. 1, so that the service can be selected, with reference to the service management table and the screen management table (S106). At this time, only some of buttons 107, 102, 103, 104, 105, and 106 that can be selected according to the access state of an apparatus may be displayed on the screen. Alternatively, the buttons that cannot be selected since the corresponding apparatus is not connected may be displayed in gray such that they cannot be selected by a pointing device. FIG. 1A shows the control screen displayed on the display unit 25 when the UPnP network 11 is in the state shown in FIG. 2. FIG. 1B shows the control screen displayed on the display unit 25 when the UPnP network 11 is in the state in which the scanner 3 shown in FIG. 2 is removed.

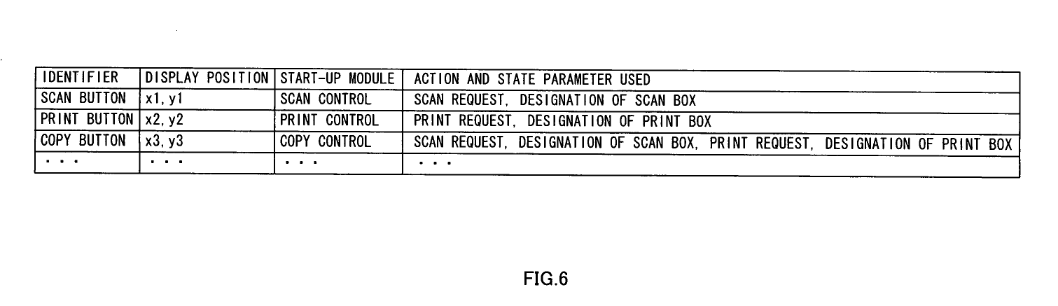

FIG. 6 is a schematic diagram illustrating a screen management table. The screen management table is a table for managing the control screen components that are used to receive, from a user, a request for the use of the services controllable by using the action and state parameters defined in the DCP. The screen management table is previously stored in the HDD 22 as a part of the control program. In each record of the screen management table, an identifier (a label, a pointer, etc.) for having access to resource data of each control screen component, display positions on the screen, information (a label, a program pointer, etc.) for calling a module that is driven when selected, and action and state parameters that are employed by a program to be is driven when selected associate with each other. The PC 1 specifies a control screen component in which all action and state parameters employed by a start-up module are set tobe ‘available’ on the service management table, and displays the specified control screen component on the screen of the display unit 25 so that it can be selected. The control screen component is also associated with the service provided by the UPnP apparatus through the screen management table and the service management table.

When the control screen component is selected by a click of a mouse, the PC 1 calls a module associated with the selected control screen component with reference to the screen management table. For example, when a scan button 107 shown in FIG. 1 is selected, a main module of the control program calls a scan control module for controlling the scan service of the scanner 3 using the label described in the screen management table. The scan control module transmits the message including the action and state parameters to the UPnP scanner 3 in a predetermined sequence to operate the UPnP scanner 3 under the control of the PC 1. The message including the action and state parameters is transmitted to the destination described in the SDD that is acquired in step S102. For example, when a print button 102 is selected, the main module of the control program calls a print control module for controlling the printer 4 using the label described in the screen management table. The print control module transmits the message including the action and state parameters to the printer 4 in a predetermined sequence to operate the printer 4 under the control of the PC 1. Furthermore, various messages, such as a scan request and a print request, may be transmitted at a time, or may be transmitted in some parts at plural times. For instance, it is possible to control one service by repeatedly transmitting a pair of a message and an action defined in the DCP that correspond to each other between the PC 1 and a device to be controlled.

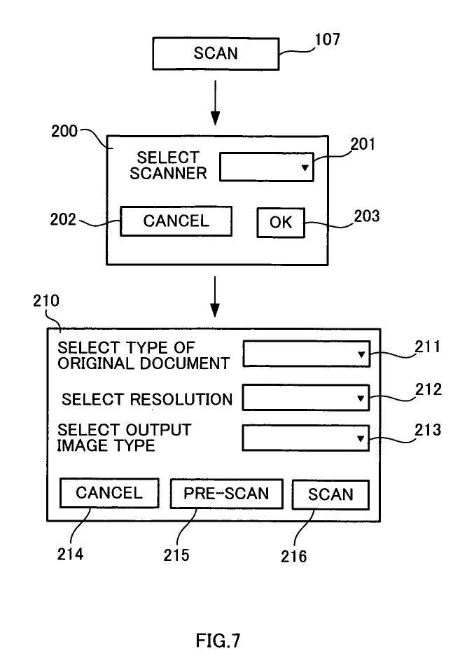

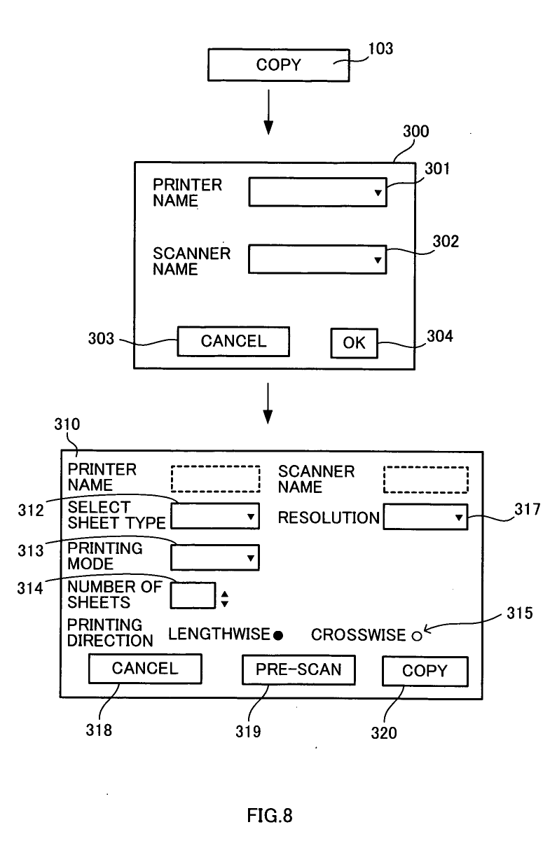

When a plurality of UPnP apparatuses providing the same service are connected to the PC 1, the PC 1 may display a screen for selecting one of these UPnP apparatuses on the display unit 25. More specifically, for example, a screen 200 shown in FIG. 7 and a screen 300 shown in FIG. 8 are displayed, and the apparatus selected by manipulating drop-down list boxes 201, 301, and 302 is specified as an object apparatus with which a module operated when the buttons 107 and 103 are selected communicates. More particularly, the URL that is described in the SDD of, for example, the specified object apparatus and is used to call the action belonging to a certain service is set as the destination of the message for calling the corresponding action. Furthermore, the destination for transmitting the message specifying the action and state parameters to the control object apparatus corresponds to control information described in claims.

In addition, the PC 1 may display a menu screen composed of the control screen components in a hierarchical way. In more detail, for example, the PC 1 may display screens 210 and 310 respectively shown in FIGS. 7 and 8 and may receive the manipulation of the control object apparatus in an interactive manner. The control screen components 211, 212, 213, 312, 313, 314, and 317 respectively displayed on the screens 210 and 310 are drop-down list boxes used for changing the state parameters. A control screen component 315 is a radio button used for changing the state parameters. Further, control screen components 214, 215, 216, 318, 319, and 320 respectively displayed on the screens 210 and 310 are buttons that are used for calling the action.

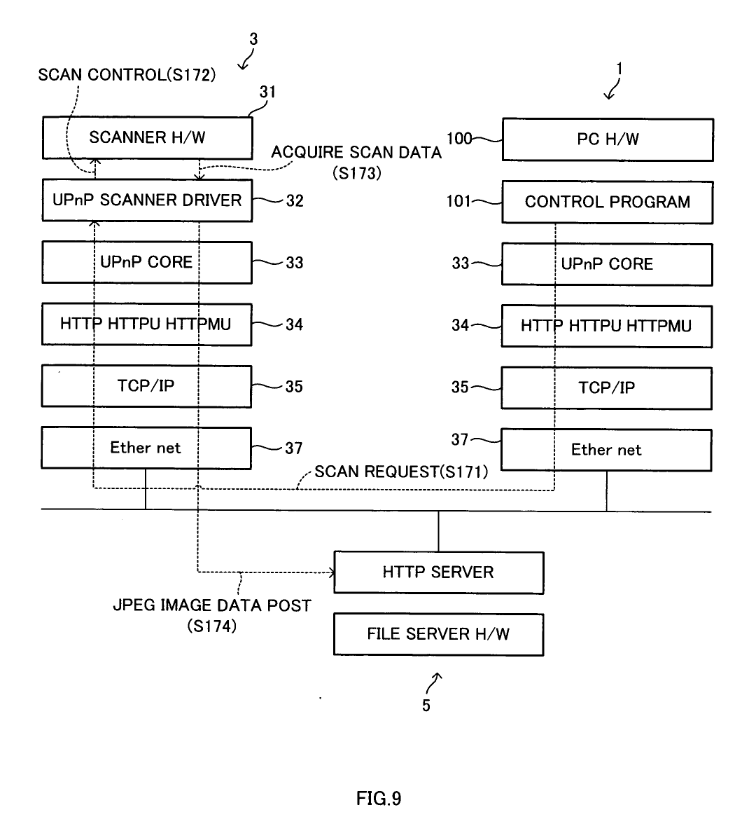

FIG. 9 is a schematic diagram illustrating a process in which the scanner 3 is driven under the control of the PC 1. When the scan button 107 is selected on the control screen shown in FIG. 1A by a click, a main module of a control program 101 calls a scan control module for controlling the scan service provided by the scanner 3 by using the label of a start-up module which is described on the screen management table. The called scan control module transmits a scan request to a UPnP scanner driver 32 via a UPnP core 33, a HTTP 34, a TCP/IP 35, and the Ethernet 37 (Ethernet is a registered trademark) (S171). In the scan request, the URL of a scan box, which is a destination of the scanned data, and various parameters, such as the resolution of the scanned data, are designated. When the scan request is received by the UPnP scanner driver 32, the UPnP scanner driver 32 controls scanner hardware 31 of the scanner 3 on the basis of the scan request (S172). When scan data is acquired by reading an original document (S173), the UPnP scanner driver 32 converts the scan data into JPEG image data. The UPnP scanner driver 32 then transmits the JPEG image data to the URL specified by the scan request via the UPnP core 33, the HTTP 34, the TCP/IP 35, and the Ethernet 37 (S174). FIG. 9 shows an example in which the JPEG image data is posted to the file server 5.

Next, functions realized by a combination of different services provided by a plurality of apparatuses will be described. These functions can include a copy function of allowing the printer 4 to print the image read by the scanner 3, a slide show function of displaying images consecutively output to the file server 5 or the digital camera 9 at predetermined intervals on the TV monitor 10, the projector 7, the digital picture frame, or the like, a music reproducing function of allowing an audio player 6 to reproduce music data randomly output from the file server 5, and so on.

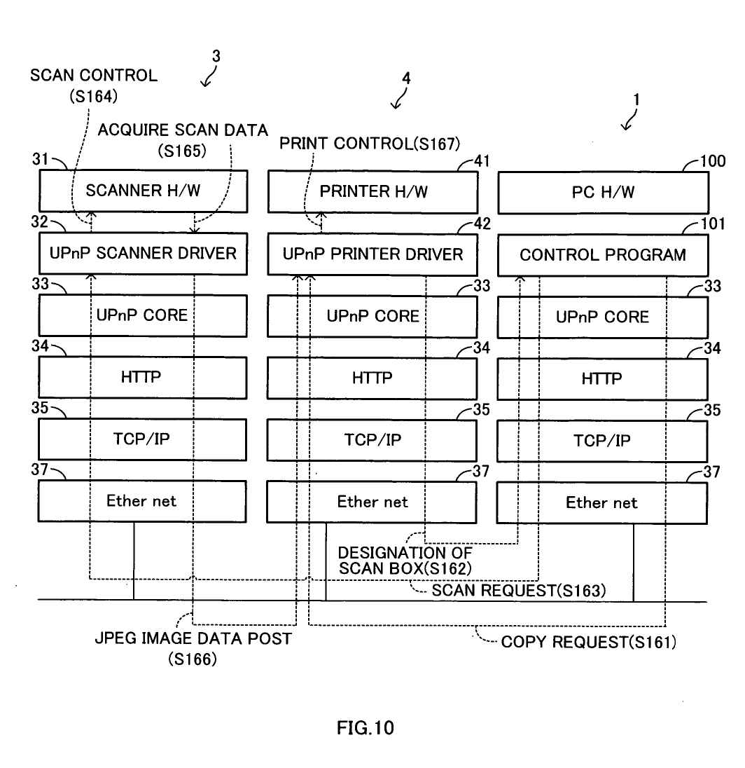

FIG. 10 is a schematic block diagram for illustrating the copy function in which the PC 1, serving as a control apparatus, controls the printer 4 to print the image read by the scanner 3.

When the copy button 103 is selected on the control screen shown in FIG. 1A by a click, the main module of the control program 101 calls a copy control module for controlling the scan service of the scanner 3 and the print service of the printer 4 using the label of the start-up module described on the screen management table. Then, the called copy control module transmits a copy request to a UPnP printer driver 42 of the printer 4 via the UPnP core 33, the HTTP 34, the TCP/IP 35, and the Ethernet 37 (S161). The UPnP printer driver 42 having received the copy request transmits the URL of a scan box as a post destination of the read image data to the control program 101 of the PC 1 via the UPnP core 33, the HTTP 34, the TCP/IP 35, and the Ethernet 37 (S162). The control program 101 then transmits the scan request specifying the URL of the scan box that is designated by the UPnP printer driver 42 to the UPnP scanner driver 32 of the scanner 3 via the UPnP core 33, the HTTP 34, the TCP/IP 35, and the Ethernet 37 (S163). When the scan request is received by the UPnP scanner driver 32, the UPnP scanner driver 32 controls scanner hardware of the scanner 3 based on the scan request (S164). When scan data is acquired (S165), the UPnP scanner driver 32 converts the scan data into JPEG image data. The UPnP scanner driver 32 then transmits the JPEG image data to the scan box of the URL designated by the scan request via the UPnP core 33, the HTTP 34, the TCP/IP 35, and the Ethernet 37 (S166). FIG. 10 shows an example in which the printer 4 itself is designated as a scan box. Alternatively, another apparatus, such as the PC 1 or the file server 5, may be designated as the scan box. In this case, a data store service provided by the apparatuses, for example, the file server is also used for copy. The UPnP printer driver 42 decodes the acquired JPEG image data and then converts the decoded image data into printing data to control printer hardware 41 of the printer 4, based on the printing data (S167). As a result, the image read by the scanner 3 is printed through the printer 4. That is, the copy function is realized by a combination of a plurality of services provided by the scanner 3 and the printer 4.

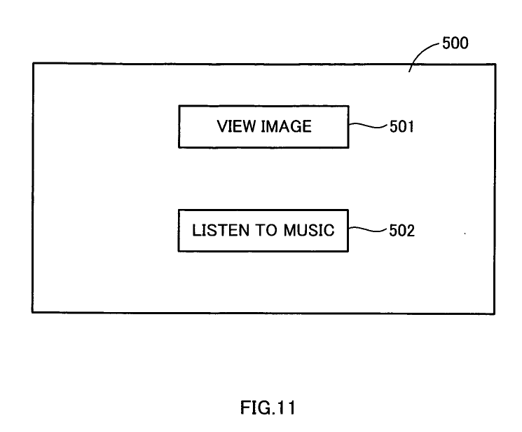

FIG. 11 is a view illustrating an object selection screen 500 for allowing a user to selects an object. In the case in which a large number of apparatuses are connected to a network, the visibility of the screen may deteriorate when all available services of the apparatuses are displayed on the menu screen of the control apparatus. In this case, a user can be allowed to select an object that employs a UPnP network on the menu screen of an upper hierarchy, and also allowed to have access to only the service provided by the apparatus corresponding to the object that is selected from the upper-level menu, on the menu screen of a lower hierarchy. This method of setting an object can include a method of setting objects that are classified according to the type of data, such as image, a music, and a text, a method of setting objects that are classified according to the behavior of a user, such as viewing an image or listening to music, a method of setting objects that are classified according to the frequency of use, such as a frequently used function or the latest used function, and the like.

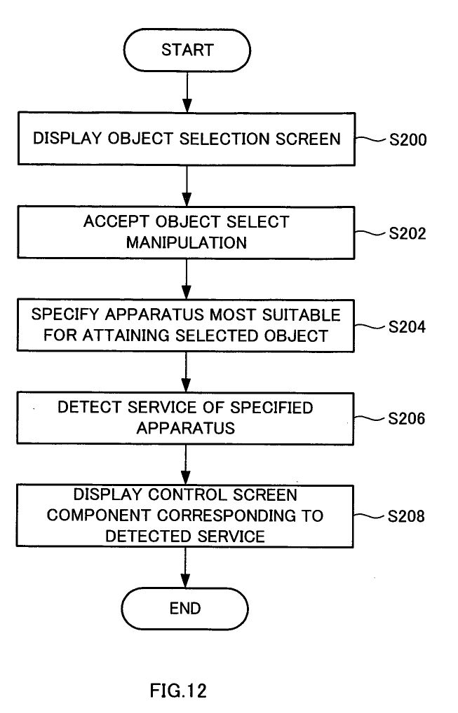

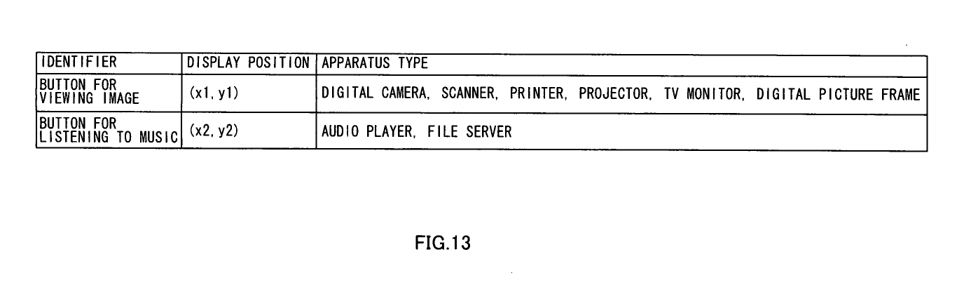

This will now be described in detail with reference to FIGS. 12 and 13. First, the PC 1, serving as a control apparatus, displays an object selection screen 500 on the display unit 25 based on the object management table shown in FIG. 13 (S200) The object management table is previously stored in the HDD 22 as a part of the control program. An object and the service of an apparatus are associated with each other by means of the object management table and the service management table. Each record of the object management table is associated with an identifier (a label, a pointer, etc.) for having access to resource data of object selection buttons 501 and 502, display positions of the object selection buttons 501 and 502 on the screen, and the type of apparatus (apparatus type), which is an access target when an object is selected, regarding each object.

If the object selection buttons 501 and 502 are selected by a click of a mouse (S202), the PC 1 specifies the device type associated with the selected button (S204), detects a service provided by a device belonging to the specified device type (S206), and displays a control screen component for having access to the detected service (S208). More specifically, for example, if the ‘image viewing’ button 501 is selected, the control screen shown in FIG. 1A is displayed on the display unit.

However, in the case in which different apparatuses belonging to the same type are connected to the network 11, when a certain object is selected, the control screen for accessing only the service provided by an apparatus most suitable for attaining the object may be displayed. In more detail, for instance, when an object ‘enjoy image’ is selected in a state in which the TV monitor and the digital picture frame are connected to the network 11, the control screen for accessing the service provided by an apparatus having a greater screen size may be displayed. An apparatus suitable for an object can be selected by comparing the SDDs of the respective apparatus.

According to the above-mentioned embodiment of the invention, in the case in which a user selects the control screen component displayed on the screen by the PC 1 serving as a control apparatus, a service associated with the selected control screen component through the action and state parameters is provided to an apparatus under the control of the PC 1. This allows a user to manipulate various of apparatuses using one PC 1 serving as a control apparatus.

Furthermore, the PC 1, serving as a control apparatus, displays the control screen component having the resource data previously stored corresponding to the DCP according to the access state of an apparatus and autonomously acquires, from the apparatus, information (control information) for controlling the apparatus. Therefore, a user does not need to input the resource data or control information of the control screen component to the PC 1, serving as a control apparatus, whenever an apparatus is additionally connected to the network 11. This facilitates the manipulation of various of apparatuses connected to a network.

Moreover, the PC 1, serving as a control apparatus, displays the control screen components for consecutive accessing the services provided by a plurality of apparatuses. Thus, a user can allow the plurality of apparatuses to be operated in cooperation with each other by manipulating the control screen components displayed on the PC 1. As a result, a user can easily employ functions through the PC 1, which are unrealizable by an individual apparatus.

Furthermore, in the above-mentioned embodiment, the invention is applied to the UPnP network. However, the invention can be applied to any network using a protocol that actively operates a plurality of network devices under the control of a specific control apparatus.

1. A control apparatus comprising:
a storage medium that is stored with control screen components;
a detection unit that detects services provided by apparatuses connected to a network;
a control screen display unit that displays, on a screen, the control screen components associated with the detected services so that the control screen components can be selected;
a control selection unit that accepts the selection of the control screen component displayed on the screen; and
a control unit that allows the service associated with the selected control screen component to be provided to the corresponding apparatus.

2. The control apparatus according to claim 1,
wherein the plurality of control screen components and the plurality of services defined by a device control protocol are stored in the storage medium such that the plurality of control screen components and the plurality of services are associated with each other,
the detection unit acquires, from the apparatuses connected to the network, control information for controlling the apparatuses, and
the control unit controls the apparatuses and allows the services to be provided to the apparatuses, based on the acquired control information.

3. The control apparatus according to claim 1,
wherein the control screen display unit displays, on the screen, the control screen components associated with functions that are realized by a combination of different services provided by the plurality of apparatuses so that the control screen components can be selected, and
the control unit allows the plurality of services for realizing the function associated with the selected control screen component to be provided to the apparatuses.

4. The control apparatus according to claim 3,
wherein the functions and the plurality of the services defined by a device control protocol are stored in the storage medium such that the plurality of services and the functions are associated with each other.

5. The control apparatus according to claim 1 or 3, further comprising:
an object selection screen display unit that displays an object on the screen so that the object can be selected; and
an object selection unit that accepts the selection of the object displayed on the screen,
wherein the control screen display unit displays, on the screen, one of the plurality of control screen components associated with the selected object such that the control screen component can be selected.

6. The control apparatus according to claim 5,
wherein the object and the plurality of services defined by a device control protocol are stored in the storage medium such that the object and the plurality of services are associated with each other.

7. A control method comprising:
detecting services provided by apparatuses connected to a network;
displaying, on a screen, one of previously stored control screen components associated with the detected service so that the control screen component can be selected;
accepting the selection of the control screen component displayed on the screen; and
providing the service associated with the selected control screen component to the corresponding apparatus.

8. A control program product that allows a computer to function as:
a detection unit that detects services provided by apparatuses connected to a network;
a control screen display unit that displays, on a screen, one of previously stored control screen components associated with the detected service so that the control screen component can be selected;
a control selection unit that accepts the selection of the control screen component displayed on the screen; and
a control unit that allows the service associated with the selected control screen component to be provided to the corresponding apparatus.
